(19) United States
(12) Patent Application Publication
(10) Pub. No.: US 2002/0030302 A1
(43) Pub. Date: Mar. 14, 2002

(54) Handicraft kit and related process for creating displayable imprints

(76) Inventors: James Paul Cleary, Sherman Oaks, CA (US); Linda Gayle Singer, Sherman Oaks, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 09/918,070

(22) Filed: Jul. 30, 2001

Related U.S. Application Data
(60) Provisional application No. 60/231,072, filed on Sep. 8, 2000.

(51) Int. Cl. B29C 33/40

(52) U.S. Cl. 264/219; 264/313

(57) ABSTRACT

A process for creating displayable imprints includes the steps of first adding water to a flexible container housing desiccated molding material, and mixing the water and molding material. The molding material is then poured into a mold which is configured to create a window. A predetermined object, such as a child's hands or feet, or a pet's paw, is imprinted in the molding material. The molding material is allowed to set, and a photograph is associated with the window by placing the photograph into a clear plastic insert having opposite faces which capture the photograph, and attaching the insert to the set molding material such that the photograph can be viewed through the window. The finished product can be displayed on an easel.

### RELATED APPLICATION

This application claims priority from provisional application Ser. No. 60/231,072, filed Sep. 8, 2000.

### BACKGROUND OF THE INVENTION

The present invention generally relates to impression products formed from plaster of paris and other molding materials such as the plaster material generally sold by U.S. Gypsum Company under the trademark ULTRACAL 30. More particularly, the present invention relates to a handicraft kit and process for producing a displayable mold providing a representation of a child's hand or foot prints, or a pet's paw prints as well as a photograph.

Manufacturers of impression products formed from plaster of paris and other materials commonly produce toys for children, masks for movie use, body part duplication for medical use, and body part duplication for display in a home or office. Such plaster representations pertain to a variety of different uses but they all relate to reproducing a desired shape for entertainment, medical use or display.

Originally reproduced shapes formed from plaster of paris were not manufactured in a kit form for consumers. Eventually, kits were introduced for consumer use, however, consumers frequently objected because the kits were overly complex to use, messy and time consuming. Thereafter, methods for reproducing a representative portion of the human body as a decorative piece for display were introduced. For example, U.S. Pat. No. 4,828,116 to Garcia (1989) shows a complex and clumsy kit process that only allows consumers the ability to duplicate whole three-dimensional objects by “sandwiching” them between two Styrofoam trays filled with plaster of paris.

In essence, this method is not effective unless a consumer only wants to mimic an entire, convex “portion of the exterior of the body of a person.” This may include an entire hand, foot or face. Also, being relatively messy, Garcia's kit requires an antiquated mixing process that may allow consumers to inhale dry plaster-of-paris particles into the lungs, causing a variety of health problems. Finally, when any other undesired contact occurs during the mixing process, there may be a potential to harm those in close proximity because the same particles may cause eye(s) and nose health problems.

Several types of molding methods have been presented. For instance, U.S. Pat. No. 4,521,171 to Noonan, Jr. (1985) discusses a hindered foot pattern method involving a heater to generate approximately 1000 watts to melt a “deformable sheet [like plastic] into the foot form” and cumbersome clamps to tightly hold a frame. Although innovative, to create a prosthetic device, this method is not in a kit form, it is extremely time consuming, and it is primarily available for use by doctors in forming plastic impressions for patients.

U.S. Pat. No. 4,397,701 (1983) to Johnson applies “plaster-impregnated” strips to a facial form to create a mask. Even though this method and kit stem from a medical use origin involving the setting of bones, it is inefficient because the wetted gauze may leak during the application, especially when it is to be “mastered by children.”

Another molding method, U.S. Pat. No. 4,215,843 (1980) to Gay relates to a toy for children involving heating and an electrical cord with alternating current that attaches to “simulate” a boiling cauldron. It produces mold figures from a gelatinous substance, containing edible “anti-bacterial preservatives and color pigments” to be melted and reformed, handled by a child and likely consumed. It is likely this is a controversial agent, even when it is assumed the gelatinous agent is non-toxic because there may be cumulative exposure over time. Although the temperature of this heating source is not supposed to exceed 135 degrees Fahrenheit, the thermostat may not warn the child playing with this toy of impending danger. Also, it may malfunction and create an unwelcome hazard. Finally, the bottled liquid and the formed, edible figures may be a choking hazard.

As an alternative to an expensive blow molding process, U.S. Pat. No. 4,100,249 (1978) to Jacques Pierre Max Giron of France relates to molding “still-fluid” by spinning the material at an accelerated speed about the central axis inside a device containing complementary halves. The inventor of this process concedes to this as more of a theoretical and not an “accepted” practice largely because of a difficult extrication of the core from the finished article, rendering the use of this invention extremely impracticable. It boasts of a clay or coarse porcelain use, however, the obsolete practice lacks an ability to control the shape of the “hollow interior space inside the article being cast.” This may result in an uneven interior, causing the finished cast article to be lopsided.

U.K. patent 908,098 (1962) to a company named Maschinenfabril-Aktiengesellschaft relates to the “holding of thermoplastic foils” by clamping one immovable frame to a second moving frame that pivots at right angles, with both moving against one another, and dependent on being held together with pins. When these pins are improperly aligned, there may be a problem operating this device during a routine shaping process. Also, this device appears to contain heavy hinges and screws that may loosen with use or become corroded over time with the forming material.

U.K. patent 943,586 (1963) to Hullmann relates to a reusable apparatus that may cast a human body part, namely a foot with an onerous method containing a ventilation chamber and a manual suction device that may clog, preventing the movement of small plastic balls that must be exposed to air pressure to create the necessary impression. Moreover, the plastic balls may not be fine enough to capture detail or they may shift when placing a flexible cover over them to create such an impression.

U.S. Pat. No. 3,309,738 (1967) to Friedman relates to a toy that may cast “wax or the like” toys like animals, soldiers or figurines. The nature of this casting process involves a child heating and transferring a “molten molding composition” by use of a light bulb and the use of awkward clamps to contain both halves or sides. However, there is no reference to a temperature gauge to warn the child of dangerous temperature and shock from alternating electrical current that may result from such temperatures. Also, there is no guideline for a safe temperature range when the child has it in use. This may result in fire, injury or even death.

U.S. Pat. No. 3,136,831 (1964) to Zinn relates to “castings with complicated coring” and this pertains primarily to producing propellant rocket engines with a method using a flexible member like a rubber impregnated cloth mandrel, that is filled with a soluble plaster and preformed to the object's desired shape. The cloth releases the agent for casting a solid propellant. However, this method lacks an ability to cast solid components without a core, which may result in wasted raw material.

U.S. Pat. No. 2,082,451 (1937) to Kivlahan relates to a plastic impression device, primarily for medical use, using plastic to obtain foot impressions to correct “imperfections and deformities.” Although this invention improves the prior art using carbon paper, it may allow material to leak when a flexible covering meant to restrain “the passage of plastic material” becomes clogged or the material flows to quickly. Also, there may be problems with the wing nuts and screws on the clamping frame loosening during the foot impression process, which may result in an incomplete impression or a person falling and injuring herself.

U.S. Pat. No. 5,712,005 (1998) to Monn relates to a memory storage box. Although this kit is rather inexpensive to manufacture, it lacks a method for preserving or protecting actual photographs. This invention duplicates photographs created to “have an appearance” like the original with a color copying process, but it does not preserve or protect the original. Rather, it protects the duplicate with an applied acrylic adhesive.

None of the above-cited references provide a kit for creating displayable imprints which is inexpensive, easy to use, and safe. Moreover, none of the above-cited references provide a process for imprinting palms of the hands or soles of the feet, or a pet's paws, as well as associating a photograph therewith. Accordingly, there is a need for a handicraft kit and process for creating such displayable imprints and photographs. The present invention fulfills these needs and provides other related advantages.

### SUMMARY OF THE INVENTION

The present invention is a process for creating displayable imprints using a molding kit. The process generally comprises the steps of pouring molding material into a mold configured to create a window, and imprinting a predetermined object in the molding material. The molding material is allowed to set and a photograph is associated with the window.

More particularly, water is first added to a flexible container housing desiccated molding material such as a plastic bag. The water and molding material are mixed with one another, such as by externally manipulating the bag to mix the water and molding material. A coloring agent may be added to the molding material. For example, blue may be added for a boy and pink for a girl.

Once adequately mixed, the molding material is poured into a mold comprising a generally planar base having a raised peripheral wall extending upwardly therefrom to define a desired configuration. The mold also includes an internal stepped wall that extends upwardly from the base to define a window and a recess.

Before the molding material has set, a predetermined object is imprinted into the molding material. Typically, such objects are the palms of a child's hands, or soles of the child's feet, or even the paws of a pet.

After the molding material has adequately set, the molding material is removed from the mold, and a photograph is placed into an insert having opposite faces which capture the photograph. The insert is placed within the recess and attached to the set molding material, typically with an adhesive like glue, stickers, double-sided tape and the like. In this manner, the photograph can be viewed through the window. The finished product can be placed upon an easel provided in the kit of the invention.

### BRIEF DESCRIPTION OF THE DRAWINGS

The accompanying drawings illustrate the invention. In such drawings:

FIG. 1 is a schematic representation of a kit embodying the present invention, and the component parts thereof;

FIG. 2 is a top plan view of a molding tray included in the kit of FIG. 1;

FIG. 3 is a cross-sectional view taken generally along line 3-3 of FIG. 2;

FIG. 4 is a perspective view of the tray of FIGS. 2 and 3; and

FIG. 5 is a flow chart illustrating the steps taken in creating a displayable imprint according to the present invention.

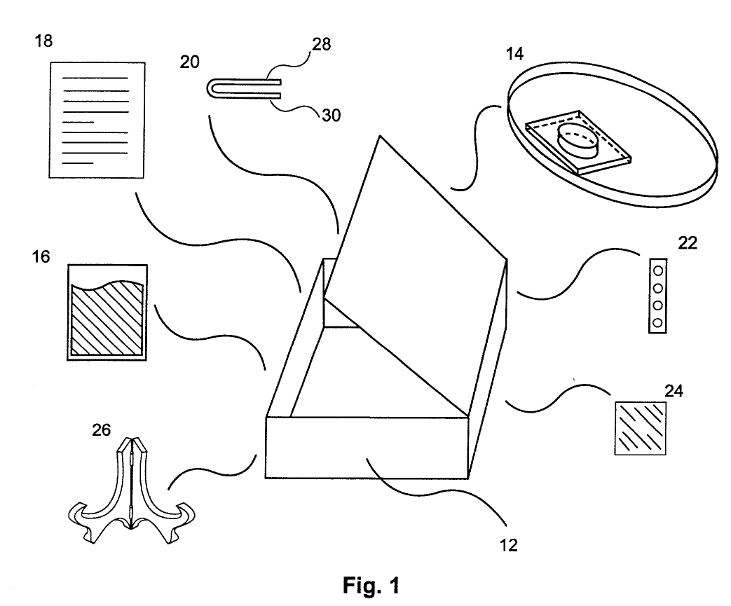

### DETAILED DESCRIPTION OF THE PREFERRED EMBODIMENT

As shown in the drawings for purposes of illustration, the present invention is concerned with a kit, generally referred to by the reference number 10, which is used in a process for creating displayable imprints. The kit 10 generally comprises a box 12 which houses a mold or tray 14, a bag 16 containing molding material such as plaster-of-paris, a direction sheet 18, an acrylic or clear plastic insert 20, double-sided stickers or tape 22, a seal 24, and an easel 26 for displaying the finished product. Typically, the easel 26 is comprised of wood which can be stained or painted to match the decor of the home or office in which the finished product is to be displayed. However, it is to be understood that the easel 26 can be comprised of any other suitable material, and be pre-finished. The insert 20 is typically a generally U-shaped member having opposite faces 28 and 30 between which a photograph is inserted so as to be held in place by the opposite faces 28 and 30. Of course, other appropriate substitute inserts can be incorporated into the kit 10 as necessary.

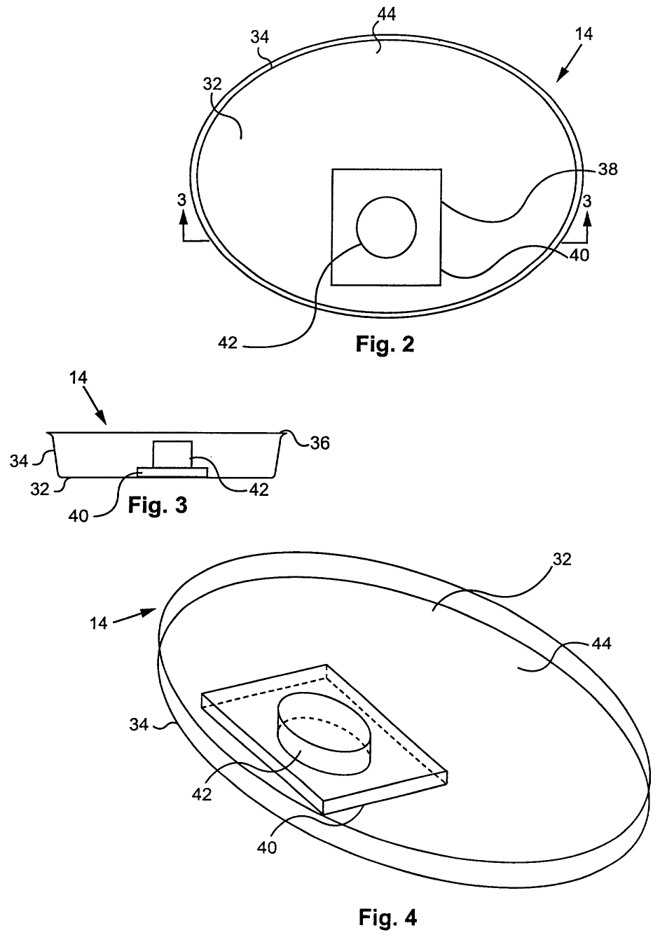

Referring now to FIGS. 2-4, the mold or tray 14 is illustrated. The tray 14 comprises a generally planar base 32 having a raised wall 34 extending upwardly therefrom to define a desired configuration. A preferable oval configuration is shown. The tray 14 of the preferred embodiment is approximately 9.0″ in length, 6.75″ in diameter, and 1.5″ in thickness. The tray 14 is preferably comprised of a flexible material, such as plastic, which may be bent or flexed to release the finished product therefrom, as will be more fully described herein. However, it is to be understood that the tray 14 may comprise any flexible material such as cardboard, paper, vinyl, rubber, nylon or any other substantially similar material which is capable of creating and releasing the finished product. Further, it is to be understood that the shape of the tray 14 can be altered such that it is a square, rectangle, heart, dog bone, pet-paw shape, cat face, etc. to meet the needs of the kit 10.

Referring now to FIG. 3, the wall 34 of the tray 14 preferably includes a slightly curved upper edge 36 which gives the tray 14 a clean, finished appearance, as well as facilitating gripping of the tray 14 during use.

The tray 14 includes an internal stepped wall 38 defining a lower recess 40 which is typically square or rectangular in shape. In a particularly preferred embodiment, the recess has approximate dimensions of 2.75 inches×2.875 inches×0.25 inches. The internal wall 38 also defines a generally tubular section 42 which defines a window in the finished product. In the preferred embodiment, the tube structure has an approximate 1.5 inch diameter, and extends from the raised recess 40 towards the upper curved edge 36 of the raised wall 34. It should be understood by the reader that the tubular structure 42 may have other geometric shapes as dictated by need. Also, the dimensions given are for reference only, and can changed to suit the needs of the kit 10. The base 32 of the tray 14 may also include a mirror image of a logo 44 or the like to identify the source of the kit 10 in the finished product. Preferably, the logo 44 is located approximately 0.5 inches below the top center of the tray base 32 and has approximate dimensions of 1.375×2.125×0.10125 inches.

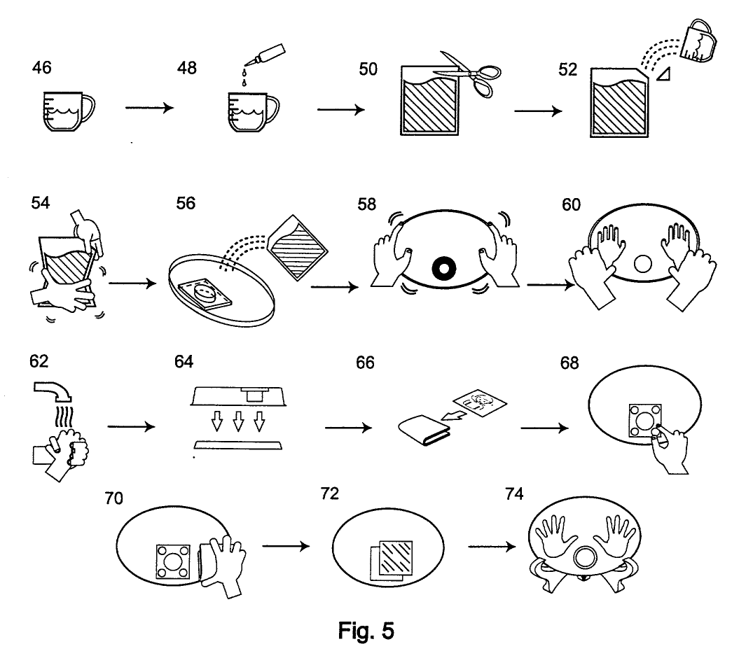

With reference now to FIG. 5, a series of graphics illustrates the steps of the process for utilizing the kit 10 in creating a displayable imprint finished product. The bag 16 typically includes approximately two pounds of plaster-of-paris which has been desiccated into its dry, powder form. A sufficient amount of water is measured 46, in this case approximately 2.5 cups, and a coloring agent, such as an F.D.A. approved food coloring agent, is optionally added 48 to create a desirable hue. For example, the user of the kit 10 may elect to add blue coloring agent if the child is a boy, and red coloring agent to create a pink finished product if the child is a girl. The bag 16 is partially opened 50, such as by cutting the corner of the bag 16, or if the bag 16 is re-sealable, partially opening the bag 16 in order to add the water 52. The bag 16 is then closed by pinching the open corner with one hand, or re-sealing the bag 16 while mixing the water and desiccated plaster-of-paris 54. The bag 16 may be agitated and externally manipulated to blend the water and plaster of paris into a blend having a watery pastry dough-like consistency. The molding mixture is then poured into the tray 14 (56), and if necessary the tray 14 is shook from side to side (58) to evenly distribute the molding material.

By using the bag 16 to mix the water and desiccated molding material, the inhalation of airborne plaster-of-paris particles is minimized, as is the contact between the moist molding material and the user's hand.

After waiting several minutes for the molding mixture to become somewhat firm, the object is impressed (60) into the molding mixture. Preferably, the object comprises the palms of a child's hands, the soles of the child's feet, or the paws of a pet. Due to the young age of the child, an adult may need to aid the child in forming the impression. The result is the object's authentic concave expression in the form of the impression. If necessary, the hands are then washed (62).

The molding material is then allowed to harden and set, after which it is removed from the tray 14 (64) by inverting the tray 14, and if necessary flexing the tray 14, to release the set molding material from the tray 14.

A photograph is then slid into the insert 20 (66), and the double-sided adhesive stickers 22 are attached within the recessed portion of the set material (68). The insert 20 is then placed within the recess and in contact with the double-sided adhesive stickers 22 (70). An opaque seal 24 is then adhered over the recess to secure the photograph inside the set molded material (72). Preferably, the seal 24 is comprised of a metallic material, such as a silver foil to provide aesthetic appeal. As a last step, the finished product, referred to as a frame, is displayed by placing it on the easel 26, or other appropriate display means (74). The finished frame bearing the imprints can then be placed upon a shelf, table, or the like for display.

It will be appreciated by the reader that the kit 10 and process of the present invention is advantageous over prior existing kits and methods as the kit does not require special skills, and includes relatively few parts making it easy to use. The kit 10 does not require electric power or heat for the molding process, and thus is much safer to use. There is no required chipping or finishing of the finished plaster material since the finished frame product is formed with the precise plaster amount, and a relatively few recyclable, plastic component parts which can be disposed of after use. The acrylic insert 20 protects and preserves the photograph within the window so as to be seen over time without the risk of being lost.

The kit 10 obviates the need for two separate decorative items, namely a standard picture frame containing a photograph, and a separate impression product. Also, the kit 10 provides a decorative product that can be completed in a relatively brief time period and can be used as an educational tool for adults who want to foster creativity and teach their children new skills, while being applicable to a wide variety of ages. The kit 10 can also be given as an unused gift to family members and loved ones. The kit 10 provides a tool for uniting family during special celebratory events and provides the ability to create and sustain a family custom with the regular use of additional kits 10 over time. The growth of the child or pet can be tracked by periodically forming impressions and associating photographs of that time era. Additionally, the final product of the kit 10 can be used as a reliable means for identifying a lost or abducted child or pet, providing a blueprint for a specific time period that may be regularly used to mark age at specific intervals.

Although an embodiment has been described in detail for purposes of illustration, various modifications may be made without departing from the scope and spirit of the invention. Accordingly, the invention is not to be limited, except as by the appended claims.

What is claimed is:

1. A process for creating displayable imprints, comprising the steps of:
pouring molding material into a mold configured to create a window;
imprinting a predetermined object in the molding material and allowing the molding material to set; and
associating a photograph with the window.

2. The process of claim 1, wherein the mold comprises a generally planar base having a raised wall extending upwardly therefrom to define a desired configuration, the mold including an internal wall extending upwardly from the base which defines the window.

3. The process of claim 1, including the steps of adding water to a flexible container housing desiccated molding material and mixing the water and molding material.

4. The process of claim 3, wherein the flexible container comprises a plastic bag and the mixing step comprises the step of externally manipulating the bag to mix the water and molding material.

5. The process of claim 1, including the step of adding a coloring agent to the molding material.

6. The process of claim 1, wherein the imprinting step comprises the step of imprinting a child's hands or feet into the molding material.

7. The process of claim 1, wherein the associating step comprises the steps of placing the photograph into an insert and attaching the insert to the set molding material such that the photograph can be viewed through the window.

8. The process of claim 7, wherein the associating step includes the step of attaching the insert to the set molding material with an adhesive material like glue, stickers, double-sided tape and the like.

9. The process of claim 7, wherein the insert comprises a clear plastic member having opposite faces which capture the photograph.

10. The process of claim 7, including the step of forming a recess in the molding material surrounding the window and configured to accept the insert.

11. A process for creating displayable imprints, comprising the steps of:
adding water to a flexible container housing desiccated molding material and mixing the water and molding material;
pouring the molding material into a mold comprising a generally planar base having a raised wall extending upwardly therefrom to define a desired configuration, the mold including an internal wall extending upwardly from the base which defines a window;
imprinting a predetermined object in the molding material and allowing the molding material to set; and
associating a photograph with the window by placing the photograph into an clear plastic insert having opposite faces which capture the photograph and attaching the insert to the set molding material such that the photograph can be viewed through the window.

12. The process of claim 11, wherein the flexible container comprises a plastic bag and the mixing step comprises the step of externally manipulating the bag to mix the water and molding material.

13. The process of claim 11, including the step of adding a coloring agent to the molding material.

14. The process of claim 11, wherein the imprinting step comprises the step of imprinting a child's hands or feet into the molding material.

15. The process of claim 11, wherein the associating step includes the step of attaching the insert to the set molding material with an adhesive material like glue, stickers, double-sided tape and the like.

16. The process of claim 11, including the step of forming a recess in the molding material surrounding the window and configured to accept the insert.

17. A process for creating displayable imprints, comprising the steps of:
adding water to a plastic bag housing desiccated molding material and externally manipulating the bag to mix the water and molding material;
adding a coloring agent to the molding material;
pouring the molding material into a mold comprising a generally planar base having a raised wall extending upwardly therefrom to define a desired configuration, the mold including an internal stepped wall extending upwardly from the base which defines a window and a recess;
imprinting a child's hands or feet in the molding material or imprinting a pet's paws and allowing the molding material to set; and
associating a photograph with the window by placing the photograph into an clear plastic insert having opposite faces which capture the photograph and placing the insert within the recess and attaching the insert to the set molding material with an adhesive material like glue, stickers, double-sided tape and the like such that the photograph can be viewed through the window.
